(19) United States
(12) Patent Application Publication
(10) Pub. No.: US 2025/0383426 A1
(43) Pub. Date: Dec. 18, 2025

(54) OPTICAL SCANNING SAFETY SENSOR

(71) Applicant: OMRON Corporation, Kyoto-shi (JP)

(72) Inventors: Satoshi NISHIUCHI, Kyoto-shi (JP); Satoshi FUJII, Kyoto-shi (JP)

(73) Assignee: OMRON Corporation, Kyoto-shi (JP)

(21) Appl. No.: 19/218,892

(22) Filed: May 27, 2025

(30) Foreign Application Priority Data
Jun. 13, 2024 (JP) 2024-096164

(51) Int. Cl. G01S 7/481; G01S 17/04; G01S 17/08

(52) U.S. Cl. CPC G01S 7/4817; G01S 17/04; G01S 17/08

(57) ABSTRACT

An optical scanning safety sensor includes: a light emitter; a photodetector; a scanning mirror that scans laser light in a circumference direction of the sensor and guides reflected light of the laser light to the photodetector; a window which allows transmission of the laser light; and a reference object which is disposed opposite the window, relative to the scanning mirror, and reflects the laser light toward the scanning mirror. The reference object includes a reflective surface including a first region and a second region whose reflectance is lower than the first region. The first and second regions are aligned along the circumference direction. A first width of the first region is less than a second width of the second region, along the circumference direction. A spot width, along the circumference direction, of the laser light projected on the reference object is greater than the first width.

### CROSS REFERENCE TO RELATED APPLICATIONS

This nonprovisional application is based on Japanese Patent Application No. 2024-096164 filed on Jun. 13, 2024 with the Japan Patent Office, the entire content of which is hereby incorporated by reference.

### BACKGROUND OF THE INVENTION

### Field of the Invention

The present disclosure relates to an optical scanning safety sensor.

### Description of the Background Art

Conventionally, an optical scanning safety sensor is known, which detects the presence of people close to dangerous machines or facilities at a production site. The optical scanning safety sensor two-dimensionally scans the light emitted from a light emitter, and measures the direction in which an object resides and the distance to the object, based on a time (time of flight) taken for a photodetector to receive the light reflected off the object. The optical scanning safety sensor that is used to protect people has a function of continuously testing the light projection and the light reception.

For example, European Patent No. 2781938 discloses a sensor having multiple reference sections at different positions. Each reference section has a light guide element for guiding the light emitted from a light emitter to a photodetector. The sensor performs reference measurement of evaluating the amount of light that is received by the photodetector when the light is incident on each reference section. In the reference measurement, the amount of received light depends on a type of reflectance of the light guide element. Therefore, the sensor compares the level of the amount of received light obtained by the reference measurement at each reference section with a target value corresponding to the light guide element to check if the light projection and the light reception are successfully performed.

### SUMMARY OF THE INVENTION

The technique disclosed in PTL 1 results in an increased size of the sensor because multiple reference sections are provided.

The present disclosure is made in view of the above problem and an object of the present disclosure is to provide a miniaturizable optical scanning safety sensor that continuously determines whether light projection and light reception are successful.

An optical scanning safety sensor according to one aspect of the present disclosure includes: a light emitter configured to emit laser light; a photodetector; a scanning mirror configured to scan the laser light in a circumference direction of the optical scanning safety sensor about a rotation shaft, and guide reflected light of the laser light to the photodetector; a window which is disposed along the circumference direction and allows transmission of the laser light; and a reference object which is disposed opposite the window, relative to the scanning mirror, and configured to reflect the laser light toward the scanning mirror. The reference object includes a first reflective surface including a first region and a second region whose reflectance is lower than the first region. The first region and the second region are aligned along the circumference direction. A first width of the first region along the circumference direction is less than a second width of the second region along the circumference direction. A spot width, along the circumference direction, of the laser light projected on the reference object is greater than the first width.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an external perspective view of an optical scanning safety sensor according to an embodiment.

FIG. 2 is a cross-sectional view of the optical scanning safety sensor according to the embodiment.

FIG. 3 is a diagram showing an optical path of laser light emitted to a reference object.

FIG. 4 is a perspective view of the reference object.

FIG. 5 is a diagram showing a processing cycle of a control board.

FIG. 6 is a diagram showing relationships between a reflective surface of the reference object and spots of the laser light.

FIG. 7 is a diagram showing a scanning position of the laser light versus an amount of light received by a photodetector.

FIG. 8 is a diagram showing the scanning position of the laser light versus an amount of light received by the photodetector when a highly reflective area has a width Wa of 0.5 mm, 0.75 mm, 1 mm, 1.5 mm, and 2 mm.

FIG. 9 is a diagram showing the scanning position of the laser light versus an amount of light received by the photodetector when a spot width W is 4.4 mm, 4.9 mm, 5.4 mm, 5.9 mm, and 6.4 mm.

FIG. 10 is a diagram showing a scanning position of the laser light versus time (time of flight (ToF)) from when the laser light is emitted to when the photodetector receives reflected light.

FIG. 11 is a diagram showing a scanning position of the laser light versus an amount of light received by the photodetector when two reflective surfaces each have a highly reflective area and a hyporeflective area and when one reflective surface has a highly reflective area and a hyporeflective area while the other reflective surface has a uniform reflectance.

### DESCRIPTION OF THE PREFERRED EMBODIMENTS

An embodiment according to the present invention will be described, with referenced to the accompanying drawings. Note that the same reference sign is used to refer to like or corresponding components in the drawings, and description thereof will not be repeated.

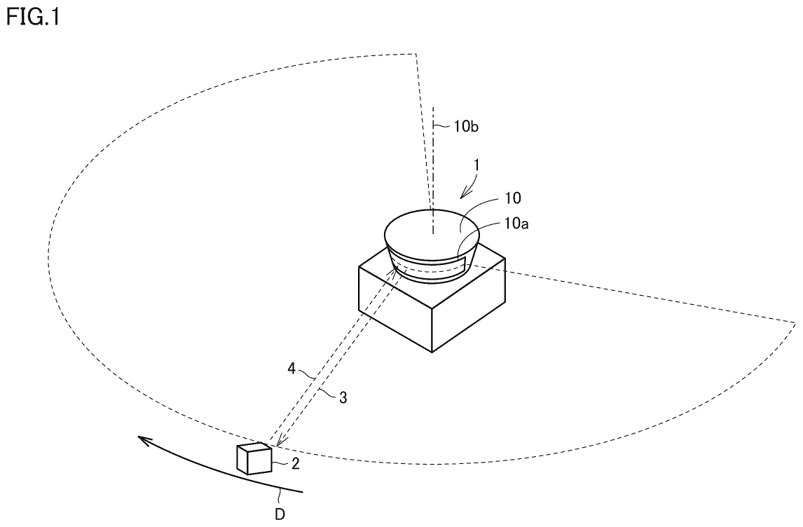

FIG. 1 is an external perspective view of an optical scanning safety sensor according to an embodiment. An optical scanning safety sensor 1 shown in FIG. 1 is a safety laser scanner, for example.

Optical scanning safety sensor 1 detects an object 2 (including humans) around optical scanning safety sensor 1 in the field of factory automation (FA), for example. Optical scanning safety sensor 1 senses an entry of an object into a preset monitoring area. A result of the sensing is used to stop FA equipment.

As shown in FIG. 1, optical scanning safety sensor 1 includes an upper housing 10 having a generally inverted truncated cone shape. A window 10a, allowing transmission of light, is provided in a portion of the side surface of upper housing 10. For example, window 10a is provided over about 270 degrees of the side surface of upper housing 10 having the inverted truncated cone shape.

Optical scanning safety sensor 1 scans laser light 3 along a circumference direction D about a rotation shaft 10b coinciding with or in parallel to the central axis of upper housing 10 having the generally inverted truncated cone shape. Laser light 3 is emitted externally after transmitting through window 10a.

When object 2 is present around optical scanning safety sensor 1, optical scanning safety sensor 1 receives reflected light 4 of laser light 3. Optical scanning safety sensor 1 measures the distance to object 2, based on a time (time of flight) from when optical scanning safety sensor 1 emits laser light 3 to when optical scanning safety sensor 1 receives reflected light 4. Optical scanning safety sensor 1 detects whether object 2 is within the preset monitoring area, based on the distance to object 2 and the direction of emission of laser light 3.

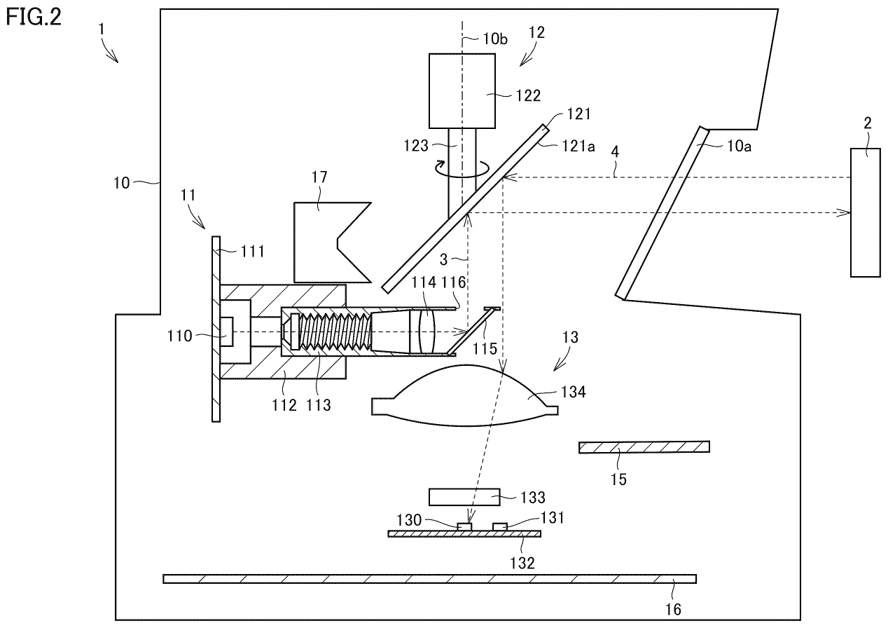

FIG. 2 is a cross-sectional view of the optical scanning safety sensor according to the embodiment. As shown in FIG. 2, optical scanning safety sensor 1 includes a light projecting unit 11, a deflection unit 12, a light receiving unit 13, a control board 15, a power board 16, and a reference object 17, as primary components.

Light projecting unit 11 includes components that are related to light projection. Specifically, light projecting unit 11 includes a light emitter 110, a substrate 111, an obstructing member 112, a lens holder 113, a lens 114, and a semi-reflective mirror 115.

Light emitter 110 is, for example, a laser diode. Light emitter 110 emits laser light 3 at predetermined time intervals (regular or irregular time intervals) (e.g., 10 to 20 μs intervals). For example, laser light 3 has a pulse width of 3 to 4 ns. The amount (intensity) of laser light 3 depends on a current supplied to light emitter 110. Light emitter 110 is mounted on substrate 111.

Obstructing member 112 has a cylindrical shape and attached to substrate 111 to surround light emitter 110. Lens holder 113 has a cylindrical shape and supports lens 114 therein. One end of lens holder 113 is inserted in obstructing member 112. The other end of lens holder 113 supports semi-reflective mirror 115.

A portion of obstructing member 112 and lens holder 113 form a cylindrical passage allowing laser light 3 to travel therethrough. Substrate 111, obstructing member 112, and lens holder 113 are formed of materials that do not transmit light.

Semi-reflective mirror 115 turns the direction of travel of laser light 3 having passed through lens 114 into a direction parallel to rotation shaft 10b to guide laser light 3 to deflection unit 12. Lens holder 113 has an opening 116 above the semi-reflective mirror 115. Laser light 3 reflected off the semi-reflective mirror 115 passes through opening 116 and is guided to deflection unit 12.

Deflection unit 12 periodically scans laser light 3. Specifically, deflection unit 12 rotary emits laser light 3 along circumference direction D (see FIG. 1) about rotation shaft 10b. When window 10a is in the direction of emission of laser light 3, laser light 3 is emitted externally after transmitting through window 10a.

Deflection unit 12 includes a scanning mirror 121, a motor 122, and a shaft 123.

Scanning mirror 121 has a reflective surface 121a. Reflective surface 121a and rotation shaft 10b form an angle of 45 degrees. Reflective surface 121a faces semi-reflective mirror 115. Therefore, scanning mirror 121 turns laser light 3 received from semi-reflective mirror 115 in a direction orthogonal to rotation shaft 10b. Shaft 123 is mounted on the back surface of scanning mirror 121 along rotation shaft 10b. Motor 122 rotates shaft 123. This rotates scanning mirror 121 about rotation shaft 10b while the angle formed between scanning mirror 121 and rotation shaft 10b is maintained at 45 degrees. As a result, scanning mirror 121 causes laser light 3 to be scanned in circumference direction D about rotation shaft 10b.

Furthermore, scanning mirror 121 receives and guides reflected light 4 of laser light 3 to a photodetector 130 included in light receiving unit 13.

Light receiving unit 13 includes a photodetector 130, an amplifier 131, a substrate 132 on which the photodetector 130 and amplifier 131 are mounted, a filter 133, and a lens 134.

Lens 134 collects the light guided by scanning mirror 121 to photodetector 130. Filter 133 transmits light in a predetermined wavelength range and obstructs light having wavelengths, other than the predetermined wavelength range. The predetermined wavelength range includes the wavelength of laser light 3 emitted from light emitter 110. For example, if laser light 3 is infrared light, an IR filter is used as filter 133.

Light receiving element 130 generates electric charges through photoelectric conversion, and is, for example, an avalanche photodiode. Light receiving element 130 outputs an output signal representing an amount of light received by photodetector 130. Amplifier 131 amplifies the output signal from photodetector 130.

IEC61496-3, which is product safety standards for safety laser scanners, demands detection of objects whose reflectance is 1.6%. However, object 2, whose distance is measured by optical scanning safety sensor 1, can include, not only such a low reflector, but also gloss floors and walls. Therefore, it is desirable that the dynamic range is wide enough to measure distances to object 2 having various reflectances. In order to implement a wide dynamic range, preferably, a log amplifier is used as amplifier 131. Amplifier 131, which is a log amplifier, converts the output signal from photodetector 130 into logarithmic scale. This allows amplifier 131 to provide a high gain to a low-level signal and provide a gain that incrementally decreases with the amplification of the signal level. As a result, optical scanning safety sensor 1 has an expanded dynamic range.

Reference object 17 is disposed opposite the window 10a, relative to scanning mirror 121, and reflects laser light 3, received from scanning mirror 121, toward scanning mirror 121. Stated differently, reference object 17 is a reflective member that is disposed between scanning mirror 121 and a portion of the side surface of upper housing 10 where window 10a is not formed.

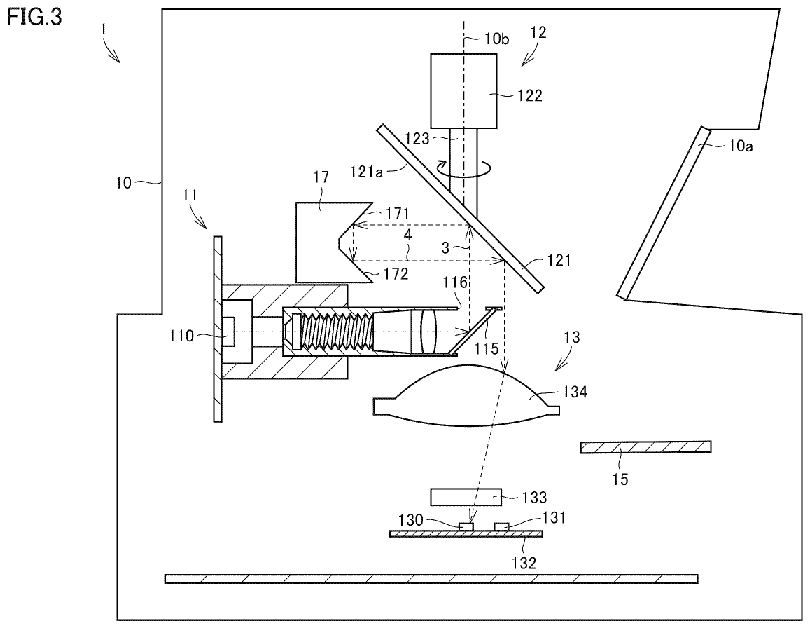

FIG. 3 is a diagram showing an optical path of the laser light emitted to the reference object. FIG. 3 shows a cross-sectional view of optical scanning safety sensor 1 when reflective surface 121a of scanning mirror 121 is oriented to reference object 17. As shown in FIG. 3, reference object 17 reflects and guides laser light 3 from scanning mirror 121 to scanning mirror 121. Light projecting unit 11, deflection unit 12, reference object 17, and light receiving unit 13 are disposed at fixed positions. Therefore, the optical path length shown in FIG. 3 is fixed.

Control board 15 controls operations of respective components inside the optical scanning safety sensor 1. Control board 15 includes, for example, a processor such as a central processing unit (CPU) or a micro processing unit (MPU), a memory, and a storage, and controls the respective components, depending on information processing.

In a period (hereinafter, referred to as a “front scan period”) in which the laser light 3 transmits through window 10a, control board 15 measures the distance to object 2, based on a time from when light emitter 110 emits laser light 3 to when photodetector 130 receives reflected light 4. Control board 15 detects whether object 2 is present in the preset monitoring area, based on the distance to object 2 and the direction of emission of laser light 3.

In a period in which the laser light 3 is emitted to reference object 17, control board 15 determines whether the time (time of flight) from when light emitter 110 emits laser light 3 to when photodetector 130 receives reflected light 4 is within a first reference range. The first reference range includes a time required for laser light 3 to travel along the optical path shown in FIG. 3 from light emitter 110 to photodetector 130. Furthermore, control board 15 determines whether the amount of light received by photodetector 130 is within a second reference range. If the time of flight is out of the first reference range for a predetermined number of times (e.g., twice) in a row, or if the amount of received light is out of the second reference range for a predetermined number of times (e.g., twice) in a row, control board 15 may output an error signal.

Power board 16 has mounted thereon various parts for supply of power to the respective components of optical scanning safety sensor 1.

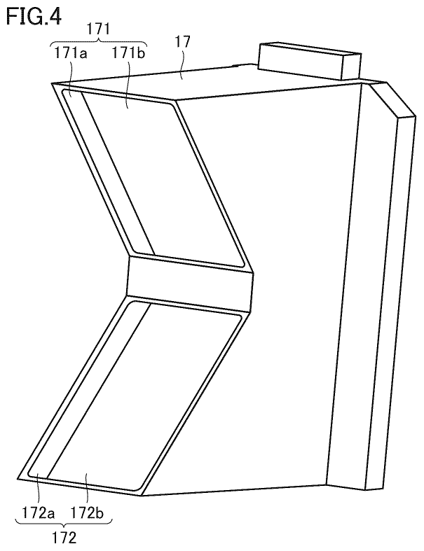

FIG. 4 is a perspective view of the reference object. As shown in FIG. 4, reference object 17 includes a reflective surface 171 and a reflective surface 172 orthogonal to reflective surface 171. This allows reference object 17 to retro-reflect laser light 3. As a result, the installation error tolerance for reference object 17 increases. In other words, reflective surface 171 guides laser light 3 from scanning mirror 121 to reflective surface 172, as shown in FIG. 3. Reflective surface 172 reflects and guides laser light 3 from reflective surface 171 to scanning mirror 121. One of reflective surfaces 171 and 172 is one example of a “first reflective surface” according to the present disclosure. The other one of reflective surfaces 171 and 172 is one example of a “second reflective surface” according to the present disclosure.

Reflective surface 171 includes a highly reflective area 171a and a hyporeflective area 171b whose reflectance is lower than highly reflective area 171a. Highly reflective area 171a and hyporeflective area 171b are connected to each other to be adjacent each other. Similarly, reflective surface 172 includes a highly reflective area 172a and a hyporeflective area 172b whose reflectance is lower than highly reflective area 172a. Highly reflective area 172a and hyporeflective area 172b are connected to each other to be adjacent each other. Highly reflective areas 171a and 172a are one example of a “first region” according to the present disclosure. Hyporeflective areas 171b and 172b are one example of a “second region” according to the present disclosure.

As laser light 3 from scanning mirror 121 reflects off the highly reflective area 171a, laser light 3 travels to highly reflective area 172a. Similarly, as laser light 3 from scanning mirror 121 reflects off the hyporeflective area 171b, laser light 3 travels to hyporeflective area 172b.

Highly reflective areas 171a and 172a and hyporeflective areas 171b and 172b diffusely reflect the laser light. This allows photodetector 130 to receive reflected light 4 from reference object 17 even if an installation error of reference object 17 occurs. In other words, the robustness of the amount of light received by photodetector 130 to an installation error of reference object 17 improves.

Highly reflective areas 171a and 172a have reflectances of, for example, 80% or greater. Hyporeflective areas 171b and 172b have reflectances of, for example, 10% or lower.

Reflective surfaces 171 and 172 are each formed of a single sheet, for example. The sheet is two-color printed. In the sheet of reflective surface 171, highly reflective area 171a is printed with a first color having a high lightness, and hyporeflective area 171b is printed with a second color having a lightness lower than the first color. Similarly, in the sheet of reflective surface 172, highly reflective area 172a is printed with the first color having a high lightness, and hyporeflective area 172b is printed with the second color having a lightness lower than the first color.

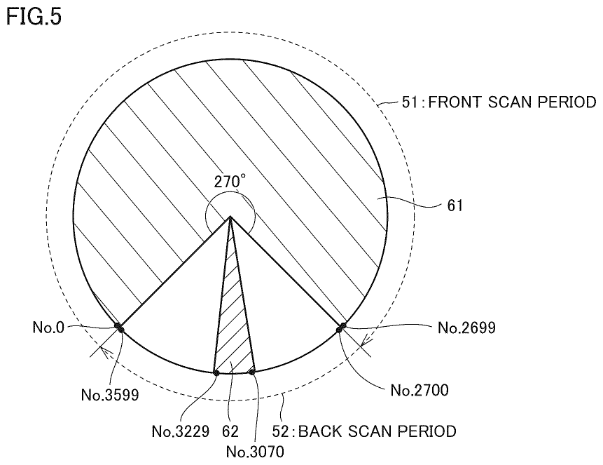

FIG. 5 is a diagram showing a processing cycle of the control board. As noted above, scanning mirror 121 scans laser light 3 along circumference direction D. The scanning cycle of laser light 3 causes one rotation of scanning mirror 121 about rotation shaft 10b. The scanning cycle includes a front scan period 51 in which the laser light 3 is emitted externally through window 10a, and a back scan period 52 in which the laser light 3 does not pass through window 10a.

Control board 15, for example, controls light emitter 110 so that the light emitter 110 emits laser light 3 each time the scanning mirror 121 rotates by 0.1 degrees. In this case, light emitter 110 emits laser light 3 3600 times in each scanning cycle. In the following, laser light 3 that is first emitted in front scan period 51 will be referred to as laser light 3 having a beam number “No. 0,” and laser light 3 that is last emitted in front scan period 51 will be referred to as laser light 3 having a beam number “No. 2699.” Laser light 3 that is first emitted in back scan period 52 will be referred to as laser light 3 having a beam number “No. 2700.” Laser light 3 that is last emitted in back scan period 52 will be referred to as laser light 3 having a beam number “No. 3599.” Subsequent to laser light 3 having a beam number “No. k,” laser light 3 having a beam number “No. k+1” is emitted.

Each time laser light 3 of the beam numbers “No. 0” to “No. 2699” is emitted, control board 15 repeats a measurement process 61. In measurement process 61, the distance to object 2 is measured based on a time from when light emitter 110 emits laser light 3 to when photodetector 130 receives reflected light 4.

As noted above, reference object 17 is disposed opposite the window 10a, relative to scanning mirror 121. Therefore, reference object 17 receives laser light 3 in back scan period 52. In the example shown in FIG. 5, reference object 17 is disposed to receive laser light 3 of the beam numbers “No. 3070” to “No. 3229.” Therefore, in a period in which the laser light 3 of the beam numbers “No. 3070” to “No. 3229” are emitted, control board 15 performs a determination process 62 to determine whether the light projection and the light reception are normal. Determination process 62 includes a first process to determine whether the time (time of flight) from when light emitter 110 emits laser light 3 to when photodetector 130 receives reflected light 4 is within the first reference range, and a second process to determine whether the amount of light received by photodetector 130 is within the second reference range.

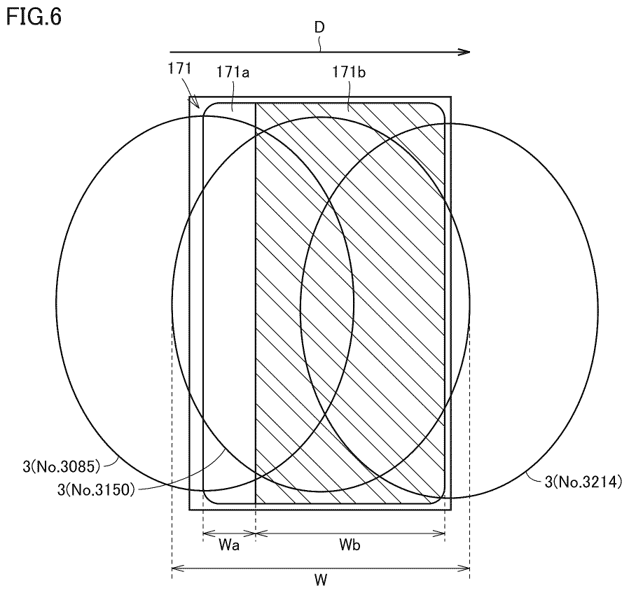

FIG. 6 is a diagram showing positional relationships between the reflective surface of the reference object and spots of the laser light. A shape of a spot of laser light 3 on reflective surface 171 of reference object 17 depends on a shape of opening 116 in light projecting unit 11. In the example shown in FIG. 6, the spots of laser light 3 on reflective surface 171 have oval shapes.

As shown in FIG. 6, reflective surface 171 has highly reflective area 171a and hyporeflective area 171b that are aligned along circumference direction D, which is the scanning direction of laser light 3. Therefore, laser light 3 is scanned to traverse highly reflective area 171a and hyporeflective area 171b. A width Wa of highly reflective area 171a along circumference direction D is less than a width Wb of hyporeflective area 171b along circumference direction D. A spot width W of laser light 3, projected on reference object 17, along circumference direction D is greater than width Wa. Spot width W is greater than width Wb. Furthermore, spot width W is greater than the width of the sheet constituting reflective surface 171 (i.e., the sum Wa+Wb of width Wa and width Wb).

Note that the width of highly reflective area 172a along circumference direction D on reflective surface 172 is Wa too, and the width of hyporeflective area 172b along circumference direction D is Wb too.

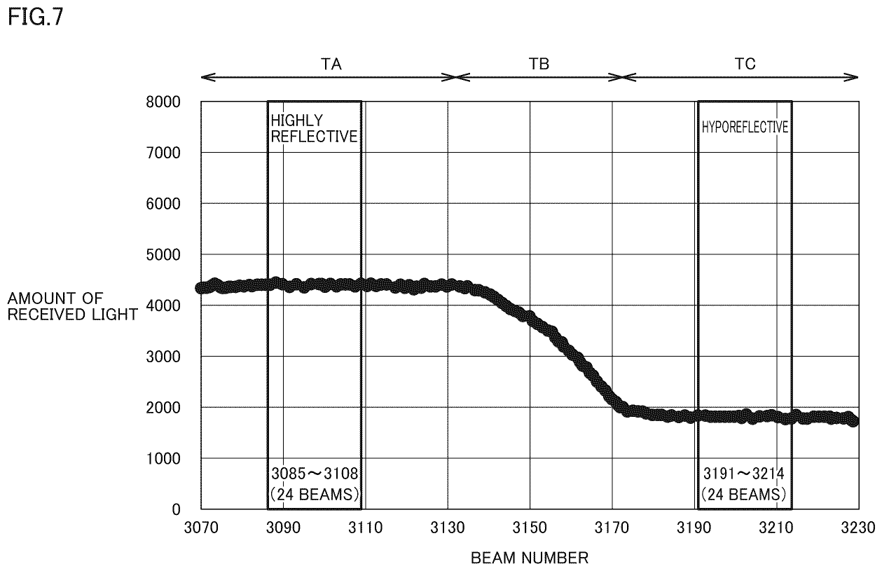

FIG. 7 is a diagram showing a scanning position of the laser light versus an amount of light received by the photodetector. The scanning position of laser light 3 is denoted by a beam number of laser light 3. Therefore, in the graph shown in FIG. 7, the beam numbers of laser light 3 are indicated on the horizontal axis and amounts of received light are indicated on the vertical axis. Note that an amount of received light is denoted by an output value of amplifier 131. FIG. 7 shows results of simulation when width Wa, width Wb, and the spot width of reference object 17 shown in FIGS. 4 and 6 are 1 mm, 3.5 mm, and 5.4 mm, respectively.

As shown in FIG. 7, a period in which the laser light 3 is scanned over reference object 17 includes: a first stable period TA in which the amount of received light is stably large; a fluctuation period TB in which the amount of received light gradually changes depending on a scan of laser light 3; and a second stable period TC in which the amount of received light is stably small. Fluctuation period TB is between first stable period TA and second stable period TC.

First stable period TA includes a moment the laser light 3 having the beam number “No. 3085” is emitted. As shown in FIG. 6, laser light 3 having the beam number “No. 3085” has the center of the spot located at an edge of reflective surface 171 on highly reflective area 171a side. Therefore, the spot of laser light 3 covers most of highly reflective area 171a. Accordingly, the amount of received light in first stable period TA is estimated to depend on reflectances of highly reflective areas 171a and 172a.

Second stable period TC includes a moment the laser light 3 having the beam number “No. 3214” is emitted. As shown in FIG. 6, laser light 3 having the beam number “No. 3214” has the center of the spot located at an edge of reflective surface 171 on hyporeflective area 171b side. Therefore, hyporeflective area 171b is dominant over the spot of laser light 3. Accordingly, the amount of received light in second stable period TC is estimated to depend on reflectances of hyporeflective areas 171b and 172b.

In this manner, even under conditions satisfying width Wa<width Wb and spot width W>width Wa, control board 15 can obtain an amount of light received by photodetector 130 upon emission of laser light 3, for example, having the beam number “No. 3085,” as an amount of received light depending on reflectances of highly reflective areas 171a and 172a. Furthermore, control board 15 can obtain the amount of light received by photodetector 130 upon emission of laser light 3 having, for example, the beam number “No. 3214,”, as an amount of received light depending on reflectances of hyporeflective areas 171b and 172b. Therefore, as the second process, control board 15 can implement a process to determine whether the amount of light received by photodetector 130 upon emission of laser light 3 having, for example, the beam number “No. 3085” is within a second reference range Ra depending on reflectances of highly reflective areas 171a and 172a. Similarly, as the second process, control board 15 can implement a process to determine whether the amount of light received by photodetector 130 upon emission of laser light 3 having, for example, the beam number “No. 3214” is within a second reference range Rb depending on reflectances of hyporeflective areas 171b and 172b. Thus, according to optical scanning safety sensor 1 of the present embodiment, whether the light projection and the light reception are successfully performed can be checked by performing the second process to evaluate the amount of received light for each of the two reflective areas having different reflectances. Moreover, since reference object 17 that has reflective surface 171 satisfying width Wa<width Wb and spot width W>width Wa may be installed in optical scanning safety sensor 1, size reduction of optical scanning safety sensor 1 is achieved.

Note that, in order to eliminate effects of errors and noise in measurement of the amount of received light, preferably, control board 15 evaluates amounts of light that are received upon emission of laser light 3 of consecutive (e.g., 24) beam numbers, rather than laser light 3 of one beam number. For example, control board 15 may determine whether a representative value (e.g., an average) of amounts of light received by photodetector 130 upon emission of laser light 3 of the beam numbers “No. 3085” to “No. 3108” is within second reference range Ra, as shown in FIG. 7. Similarly, control board 15 may determine whether a representative value of amounts of light received by photodetector 130 upon emission of laser light 3 of the beam number “No. 3191” to “No. 3214” is within second reference range Rb. Furthermore, control board 15 may evaluate variations (e.g., a variance) in amount of received light upon emission of laser light 3 of the beam numbers “No. 3085” to “No. 3108.” Similarly, control board 15 may evaluate variations (e.g., a variance) in amount of received light upon emission of laser light 3 of the beam number “No. 3191” to “No. 3214.”

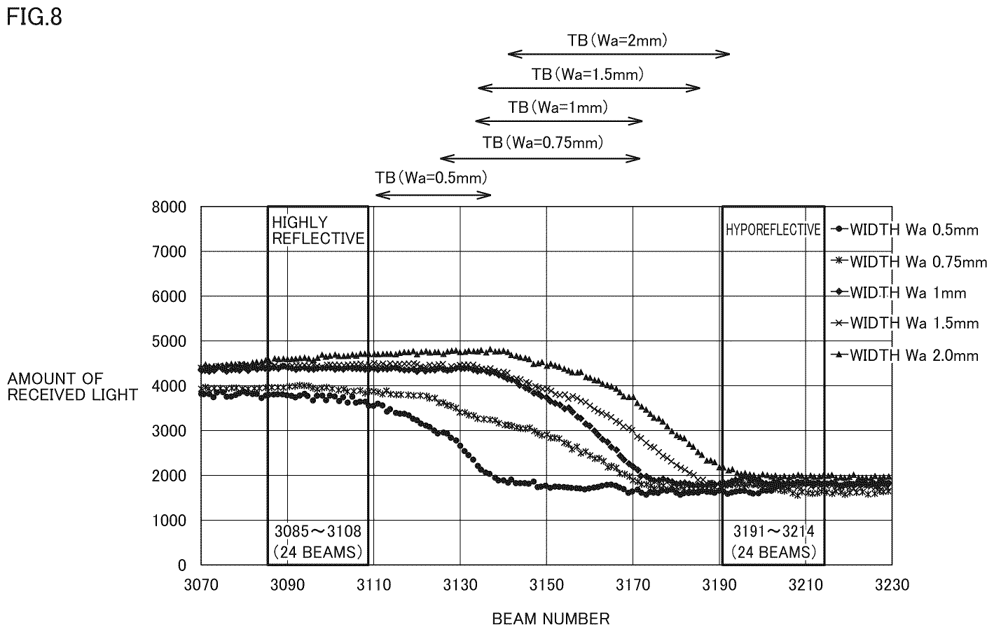

FIG. 8 is a diagram showing a scanning position of the laser light versus an amount of light received by the photodetector when width Wa of the highly reflective area is 0.5 mm, 0.75 mm, 1 mm, 1.5 mm, and 2 mm. Note that FIG. 8 shows results of simulation when sum Wa+Wb of widths Wa and Wb and the spot width of reference object 17 shown in FIGS. 4 and 6 are 4.5 mm and 5.4 mm, respectively. Similarly to FIG. 7, the period, in which the laser light 3 is scanned over reference object 17, includes: the first stable period in which the amount of received light is stably large; fluctuation period TB in which the amount of received light gradually changes depending on a scan of laser light 3; and the second stable period in which the amount of received light is stably small, provided that the durations of the first stable period, fluctuation period TB, and the second stable period depend on width Wa.

When width Wa is 0.5 to 1.5 mm, fluctuation period TB does not overlap with periods that are subject to the second process (the periods for the beam numbers “No. 3085” to “No. 3108” and “No. 3191” to “No. 3214”). Therefore, preferably, width Wa is 0.5 to 1.5 mm. Stated differently, preferably, the ratio (Wa/(Wa+Wb)) of Wa to the width (i.e., Wa+Wb) of reflective surface 171 along circumference direction D is 1/9 to ⅓.

When width Wa is 0.75 to 1.5 mm, differences further increase between fluctuation period TB and the periods that are subject to the second process (the periods for the beam numbers “No. 3085” to “No. 3108” and “No. 3191” to “No. 3214”). Therefore, more preferably, width Wa is 0.75 to 1.5 mm. Stated differently, more preferably, the ratio (Wa/(Wa+Wb)) of Wa to the width (i.e., Wa+Wb) of reflective surface 171 along circumference direction D is ⅙ to ⅓.

Meanwhile, if laser light 3 specularly reflects off the highly reflective areas 171a and 172a, an intense amount of light can be guided to photodetector 130. In general, if the intensity of light received by photodetector 130 is too strong, an output signal of photodetector 130 is saturated. Therefore, when laser light 3 specularly reflects off the highly reflective areas 171a and 172a, the amount of light received by photodetector 130 is not sufficient to determine whether photodetector 130 has successfully received reflected light 4 from highly reflective areas 171a and 172a or the output signal of photodetector 130 is saturated due to a failure of light receiving unit 13 (e.g., a circuit on substrate 132). However, highly reflective areas 171a and 172a diffusely reflect laser light 3, as noted above. Therefore, the output signal of photodetector 130 is not saturated even when photodetector 130 receives reflected light 4 from highly reflective areas 171a and 172a. This allows control board 15 to determine, based on amounts of received light corresponding to the beam numbers “No. 3085” to “No. 3108,” whether photodetector 130 has successfully received reflected light 4 from highly reflective areas 171a and 172a or the output signal of photodetector 130 is saturated due to a failure of light receiving unit 13.

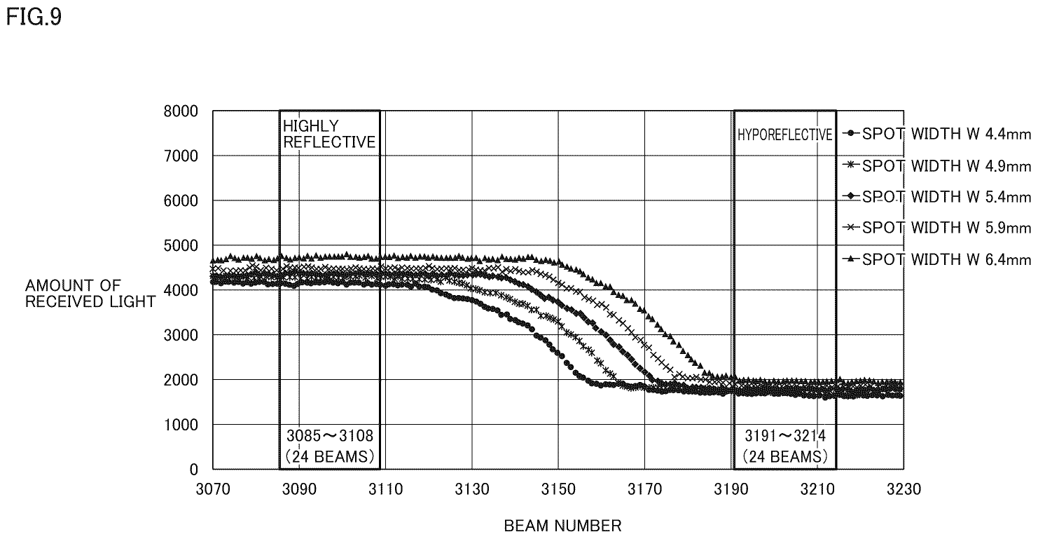

FIG. 9 is a diagram showing the scanning position of the laser light versus an amount of light received by the photodetector when spot width W is 4.4 mm, 4.9 mm, 5.4 mm, 5.9 mm, and 6.4 mm. Note that FIG. 9 shows results of simulation when widths Wa and Wb of reference object 17 shown in FIGS. 4 and 6 are 1 mm and 3.5 mm, respectively. Similarly to FIG. 7, the period, in which the laser light 3 is scanned over reference object 17, includes: the first stable period in which the amount of received light is stably large; the fluctuation period in which the amount of received light gradually changes depending on a scan of laser light 3; and the second stable period in which the amount of received light is stably small, provided that the durations of the first stable period, the fluctuation period, and the second stable period depend on spot width W.

As shown in FIG. 9, when spot width W is in a range of 4.4 mm to 6.4 mm, the fluctuation period does not overlap with the periods that are subject to the second process (the periods for the beam numbers “No. 3085” to “No. 3108” and “No. 3191” to “No. 3214”). Therefore, preferably, spot width W is 4.4 mm to 6.4 mm. Stated differently, preferably, the ratio (W/(Wa+Wb)) of spot width W to the width (i.e., Wa+Wb) of reflective surface 171 along circumference direction D is 0.98 to 1.42.

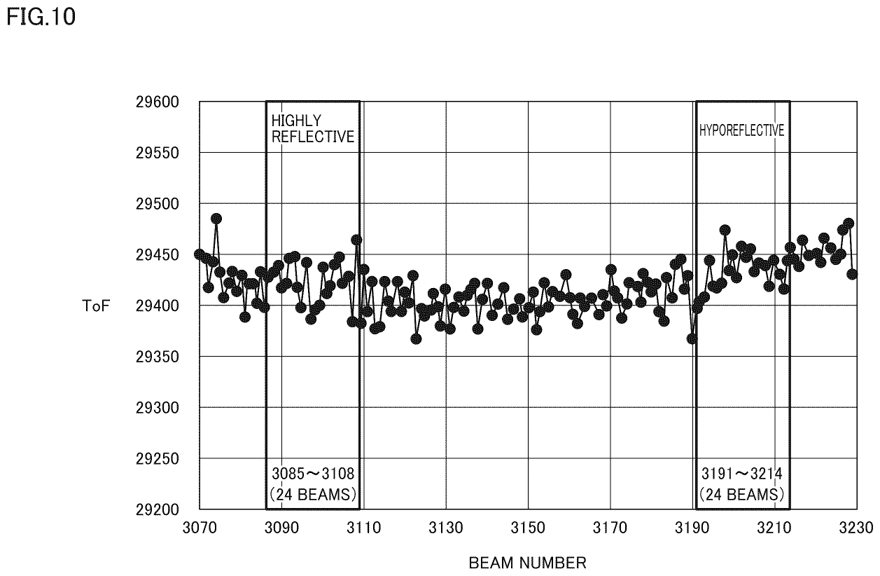

FIG. 10 is a diagram showing a scanning position of the laser light versus time (time of flight (ToF)) from when the laser light is emitted to when the photodetector receives reflected light. As shown in FIG. 10, when the light projection and the light reception are successfully performed, the time of flight is stable. Therefore, for example, as the first process, control board 15 determines whether the time of flight corresponding to laser light 3 of the beam numbers “No. 3085” to “No. 3108” and “No. 3191” to “No. 3214” are within the first reference range. This allows control board 15 to check if the light projection and the light reception are successfully performed.

In the above description, reference object 17 has the highly reflective area and the hyporeflective area for each of reflective surfaces 171 and 172. However, reference object 17 may be designed to have the highly reflective area and the hyporeflective area in only one of reflective surfaces 171 and 172 and the other one of reflective surfaces 171 and 172 having a uniform reflectance. For example, a reflective surface 172 may have a uniform reflectance.

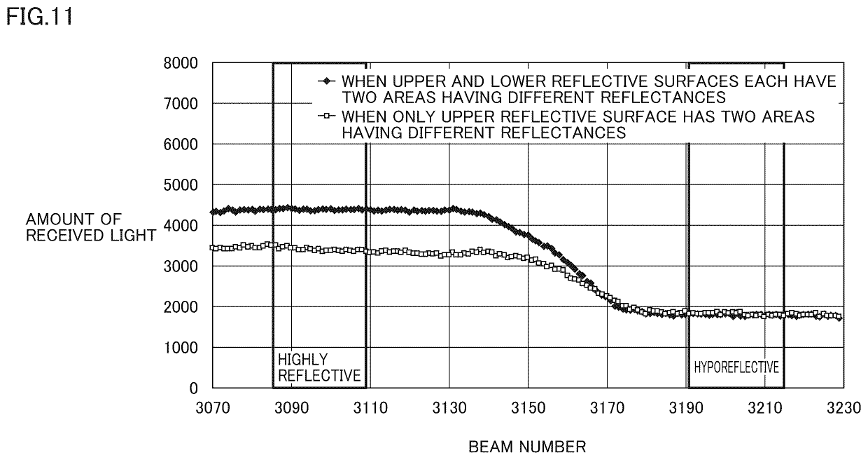

FIG. 11 is a diagram showing a scanning position of the laser light versus an amount of light received by the photodetector when two reflective surfaces each have the highly reflective area and the hyporeflective area and when one reflective surface has the highly reflective area and the hyporeflective area while the other reflective surface has a uniform reflectance. In other words, FIG. 11 shows a scanning position of the laser light versus an amount of light received by the photodetector when reflective surfaces 171 and 172 each have the highly reflective area and the hyporeflective area and when reflective surface 171 has the highly reflective area and the hyporeflective area and reflective surface 172 has a uniform reflectance of 10%. Note that FIG. 11 shows results of simulation when width Wa is 1.0 mm and width Wb is 3.5 mm.

In either case, an obvious difference occurs between the amount of light received by photodetector 130 upon emission of laser light 3 of the beam numbers “No. 3085” to “No. 3108” and the amount of light received by photodetector 130 upon emission of laser light 3 of the beam number “No. 3191” to “No. 3214,” as shown in FIG. 11. Therefore, control board 15 can determine whether the light projection and the light reception are normal, according to whether the amounts of light received by photodetector 130 upon emission of laser light 3 of the beam numbers “No. 3085” to “No. 3108” are within second reference range Ra depending on a reflectance of highly reflective area 171a. Furthermore, control board 15 can determine whether the light projection and the light reception are normal, according to whether the amounts of light received by photodetector 130 upon emission of laser light 3 of the beam number “No. 3191” to “No. 3214” are within second reference range Rb depending on a reflectance of hyporeflective area 171b.

### <Appended Note>

As described above, the present embodiment includes the following disclosure:

### (Configuration 1)

An optical scanning safety sensor (1), including:
a light emitter (110) configured to emit laser light (3);
a photodetector (130);
a scanning mirror (121) configured to scan the laser light (3) in a circumference direction of the optical scanning safety sensor (1) about a rotation shaft (10b), and guide reflected light (4) of the laser light (3) to the photodetector (130);
a window (10a) which is disposed along the circumference direction and allows transmission of the laser light (3); and
a reference object (17) which is disposed opposite the window (121), relative to the scanning mirror (121), and configured to reflect the laser light (3) toward the scanning mirror (121), wherein
the reference object (17) includes a first reflective surface (171, 172) including a first region (171a, 172a) and a second region (171b, 172b) whose reflectance is lower than the first region (171a, 172a),
the first region (171a, 172a) and the second region (171b, 172b) are aligned along the circumference direction,
a first width (Wa) of the first region (171a, 172a) along the circumference direction is less than a second width (Wb) of the second region (171b, 172b) along the circumference direction, and
a spot width (W), along the circumference direction, of the laser light (3) projected on the reference object (17) is greater than the first width (Wa).

According to the present disclosure, the laser light is scanned to traverse the first region and the second region. If the spot of the laser light covers most of the first region, the amount of light received by the photodetector depends on a reflectance of the first region. In contrast, if the area of the first region included in the spot of the laser light is reduced to some extent and the second region is dominant over the spot, the amount of light received by the photodetector depends on a reflectance of the second region. Therefore, the optical scanning safety sensor can check whether the light projection and the light reception are successfully performed by evaluating the amount of received light for each of the two areas having different reflectances. Moreover, since the reference object that has the first reflective surface satisfying the first width<the second width and the spot width>the first width may be installed in the optical scanning safety sensor, size reduction of the optical scanning safety sensor is achieved.

### (Configuration 2)

The optical scanning safety sensor (1) according to Configuration 1, wherein the first region (171a, 172a) diffusely reflects the laser light.

According to the present disclosure, the output signal of the photodetector is not saturated even when the photodetector receives the reflected light from the first region. Therefore, the optical scanning safety sensor can determine, based on the amount of light received from the first region, whether the photodetector has successfully received the reflected light from the first region or the output signal of the photodetector is saturated due to a failure of the photodetector or its peripheral circuit.

### (Configuration 3)

The optical scanning safety sensor (1) according to Configuration 1 or 2, wherein
the reference object (17) further includes a second reflective surface (172, 171) orthogonal to the first reflective surface (171, 172), wherein
one of the first reflective surface (171, 172) and the second reflective surface (172, 171) reflects and guides the laser light to the other one of the first reflective surface (171, 172) and the second reflective surface (172, 171).

According to the present disclosure, the reference object can retro-reflect the laser light. As a result, an installation error tolerance for the reference object increases.

### (Configuration 4)

The optical scanning safety sensor (1) according to any of Configurations 1 to 3, wherein
the first reflective surface (171, 172) is configured of one sheet, wherein
the first region (171a, 172a) is a region of the one sheet which is printed with a first color, and
the second region (171b, 172b) is a region of the one sheet which is printed with a second color whose brightness is lower than the first color.

According to the present disclosure, the first reflective surface can be manufactured by a simple print process.

While the embodiment according to the present invention has been described above, the presently disclosed embodiment should be considered in all aspects illustrative and not restrictive. The scope of the present invention is defined by the appended claims. All changes which come within the meaning and range of equivalency of the appended claims are to be embraced within their scope.

What is claimed is:

1. An optical scanning safety sensor, comprising:
a light emitter configured to emit laser light;
a photodetector;
a scanning mirror configured to scan the laser light in a circumference direction of the optical scanning safety sensor about a rotation shaft, and guide reflected light of the laser light to the photodetector;
a window which is disposed along the circumference direction and allows transmission of the laser light; and
a reference object which is disposed opposite the window, relative to the scanning mirror, and configured to reflect the laser light toward the scanning mirror, wherein
the reference object includes a first reflective surface including a first region and a second region whose reflectance is lower than the first region,
the first region and the second region are aligned along the circumference direction,
a first width of the first region along the circumference direction is less than a second width of the second region along the circumference direction, and
a spot width, along the circumference direction, of the laser light projected on the reference object is greater than the first width.

2. The optical scanning safety sensor according to claim 1, wherein
the first region diffusely reflects the laser light.

3. The optical scanning safety sensor according to claim 1, wherein
the reference object further includes a second reflective surface orthogonal to the first reflective surface, wherein
one of the first reflective surface and the second reflective surface reflects and guides the laser light to the other one of the first reflective surface and the second reflective surface.

4. The optical scanning safety sensor according to claim 1, wherein
the first reflective surface is configured of one sheet, wherein
the first region is a region of the one sheet which is printed with a first color, and
the second region is a region of the one sheet which is printed with a second color whose brightness is lower than the first color.

5. The optical scanning safety sensor according to claim 2, wherein
the reference object further includes a second reflective surface orthogonal to the first reflective surface, wherein
one of the first reflective surface and the second reflective surface reflects and guides the laser light to the other one of the first reflective surface and the second reflective surface.

6. The optical scanning safety sensor according to claim 2, wherein
the first reflective surface is configured of one sheet, wherein
the first region is a region of the one sheet which is printed with a first color, and
the second region is a region of the one sheet which is printed with a second color whose brightness is lower than the first color.
